(19) United States
(12) Patent Application Publication
(10) Pub. No.: US 2017/0306726 A1
(43) Pub. Date: Oct. 26, 2017

(54) STUCK PIPE PREDICTION

(71) Applicant: KING ABDULLAH UNIVERSITY OF SCIENCE AND TECHNOLOGY, Thuwal (SA)

(72) Inventors: Majed ALZAHRANI, Thuwal (SA); Fawaz ALSOLAMI, Thuwal (SA); Igor CHIKALOV, Thuwal (SA); Salem ALGHARBI, Thuwal (SA); Faisal ABOUDI, Thuwal (SA); Musab KHUDIRI, Thuwal (SA)

(21) Appl. No.: 15/507,777

(22) PCT Filed: Sep. 2, 2015
(86) PCT No.: PCT/IB2015/001945

§ 371 Date: Mar. 1, 2017

Related U.S. Application Data
(60) Provisional application No. 62/044,509, filed on Sep. 2, 2014.

(51) Int. Cl. E21B 41/00; E21B 47/00; E21B 47/09; G06F 17/50

(52) U.S. Cl. CPC E21B 41/0092; G06F 17/5009; E21B 47/00; E21B 47/09; G06F 2217/16

(57) ABSTRACT

Disclosed are various embodiments for a prediction application to predict a stuck pipe. A linear regression model is generated from hook load readings at corresponding bit depths. A current hook load reading at a current bit depth is compared with a normal hook load reading from the linear regression model. A current hook load greater than a normal hook load for a given bit depth indicates the likelihood of a stuck pipe.

### CROSS-REFERENCE TO RELATED APPLICATION

This application is the National Stage of International Application No. PCT/162015/001945, filed 2 Sep. 2015, which claims the benefit of and priority to U.S. Provisional Application Ser. No. 62/044,509, having the title “STUCK PIPE PREDICTION,” filed on 2 Sep. 2014, the entire disclosures of which are incorporated by reference in their entireties as if fully set forth herein.

### BACKGROUND

Maintaining wellbore stability and monitoring drilling None Productive Time (NPT) are two main key factors in improving safety and drilling efficiency while minimizing problem costs associated with well construction and production operations. Despite the need to understand the conditions which create drilling operation risks such as wellbore instabilities, there is no industry consensus regarding which stability analysis methodologies are most applicable under varying geologic conditions. Therefore, the reliance on the manual real-time data interpretation and human intervention is a key although it is currently performed inefficiently.

Pipe sticking is a common, critical problem that can affect wellbore stability. Typically, the stuck pipe is more likely when the pipe goes horizontally deep. It can have a huge negative impact on drilling operation safety and efficiency. The cost of fixing stuck pipe problem can reach millions of dollars per single incident. Preemptively detecting conditions that may lead to a stuck pipe may prevent accumulating costs associated with repairing the problem.

### SUMMARY

A pipe may become stuck during a drilling operation, necessitating that drilling be stopped to remedy the problem. In the oil industry, a stuck pipe is considered one of the biggest problems that can affect wellbore stability. A pipe is considered stuck if it cannot be freed from the hole without damaging the pipe, and without exceeding the drilling rig's maximum allowed hook load. Pipe sticking may include differential pressure pipe sticking or mechanical pipe sticking. Usually, pipe sticking occurs when the pipe goes horizontally deep after a certain depth. When a pipe becomes stuck, the drilling operation may need to be halted in order to repair the stuck pipe, causing substantial losses in revenue. Typically, the cost of a stuck pipe can reach millions of dollars per single incident.

A new prediction model is provided herein for monitoring and predicting drilling troubles. In one or more embodiments the prediction model incorporates an application that can monitor drilling conditions in real time and apply machine learning techniques to determine if a pipe is at risk of becoming stuck. The model can facilitate predicting key drilling attributes in real time. In one or more aspects it can predict hook-load values in real-time and near-real-time during the Pull-Out-of-Hole (POOH) operation as early as 3 hours in advance to enable early intervention and mitigation of potential stuck pipe drilling troubles. The prediction model, can also be trained either using offset wells data, or real-time operational data. Coupling these forecasts with simulation capabilities, advanced engineering algorithms and advanced IT technologies and techniques can significantly improve Drilling engineers responsiveness and intervention to reduce operational risks and optimize Drilling None Productive Time (NPT) which in turn can lead to optimum field operation. In addition, it can provide an environment for Autonomous Drilling such as Auto-Driller technologies, Remote execution and Controlling of Drilling and Geo-steering operations.

In one or more embodiments the prediction application monitors the bit depth and hook load of an active pipe. The prediction application can generate a linear regression model with or without previous training for detecting possible stuck pipe conditions. If conditions are satisfied that indicate that a pipe is likely to become stuck, an alert is generated, allowing remedial action to be preemptively taken.

In an embodiment, we provide a method for monitoring and predicting a stuck pipe. The method can comprise: a) generating, by at least one computing device, a linear regression model based at least in part on a plurality of hook load readings each corresponding to a respective one of a plurality of bit depths; b) obtaining, by the at least one computing device, a first hook load reading at another bit depth; c) determining, by the at least one computing device, whether the first hook load reading is greater than a second hook load reading obtained from the linear regression model; and d) generating, by the at least one computing device, an indication of a risk of stuck pipe in response to the first hook load reading being greater than the second hook load reading.

In an embodiment, a system for stuck pipe prediction is provided. The system can comprise: at least one device for receiving a plurality of hook load readings each corresponding to a respective one of a plurality of bit depths; at least one computer processing device; and an application executable in the at least one computer processing device, the application comprising logic that: generates, by the at least one computer processing device, a linear regression model based at least in part on a plurality of hook load readings each corresponding to a respective one of a plurality of bit depths; obtains, by the at least one computer processing device, a first hook load reading at another bit depth; determines, by the at least one computing processing device, whether the first hook load reading is greater than a second hook load reading obtained from the linear regression model; and

generates, by the at least one computer processing device, an indication of a risk of stuck pipe in response to the first hook load reading being greater than the second hook load reading.

In an embodiment, a non-statutory computer readable medium is provided employing a program executable in at least one computing device, comprising code that: generates, by at least one computing device, a linear regression model based at least in part on a plurality of hook load readings each corresponding to a respective one of a plurality of bit depths; obtains, by the at least one computing device, a first hook load reading at another bit depth; determines, by the at least one computer processing device, whether the first hook load reading is greater than a second hook load reading obtained from the linear regression model; and generates, by the at least one computing device, an indication of a risk of stuck pipe in response to the first hook load reading being greater than the second hook load reading.

In any one or more aspects of any one or more of the embodiments, generating the linear regression model can comprise obtaining the plurality of hook load readings from a well from which the first hook load reading is obtained. Obtaining the plurality of hook load readings can comprise filtering those of the hook load readings meeting a predefined threshold. The linear regression model can be generated in response to obtaining a number of hook load readings meeting a predefined threshold. Generating the linear regression model can comprise obtaining the plurality of hook load readings from a plurality of wells distinct from a well from which the first hook load reading is obtained. Obtaining the plurality of hook load reading can comprise filtering those of the hook load readings meeting a predefined threshold. The predefined threshold can be 170 klbs. The linear regression model can be generated to minimize a sum squared error. The linear regression model can be regenerated based at least in part on the first hook load reading. Any one or more of these steps or processes can be carried out by a computing device or a computing processing device and/or by code or logic executable therein.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1 and 2 are flowcharts illustrating examples of functionality implemented as portions of a prediction application executed in a computing environment according to various embodiments of the present disclosure.

FIG. 3 is a schematic block diagram that provides one example illustration of a computing environment configured to execute the prediction application according to various embodiments of the present disclosure.

FIG. 4 depicts ALRA-TPR and ALRA-FPR data from a running of the adaptive linear regression algorithm for 4 randomly selected wells, the adaptive linear regression algorithm run five times.

FIG. 5 depicts charts showing the obtained regression model of different wells.

FIGS. 6A and 6B depict charts showing some record readings and the alerts of Well-10.

FIG. 7 depicts ALRA-TPR and FPR data from use of eight wells for training to obtain a linear regression model and four wells used for testing, the linear regression algorithm run five times.

FIG. 8 depicts charts showing the obtained regression model of different runs.

FIGS. 9A and 9B depict charts showing some record readings and the alerts of Well-2.

FIGS. 10A-10C depict charts showing examples of real alerts provided by our present system and method.

### DETAILED DESCRIPTION

In the following discussion, a general description of the system and its components is provided, followed by a discussion of the operation of the same. Further embodiments of a prediction application are provided in “Real-Time Stuck Pipe Trouble Prediction during Drilling Operation Using Hook Load Parameter” by Majed Alzahrani, which is hereby incorporated by reference in its entirety, a copy of which is attached hereto as Appendix A.

In one or more embodiments the present prediction application can be configured to apply a liner regression approach that models the relationship between a scalar dependent variable y and one or more explanatory variables denoted X. Linear regression can be used to fit a predictive model to an observed data set of y and X values. After developing such a model, if an additional value of X is then given without its accompanying value of y, the fitted model can be used to make a prediction of the value of y. An exemplary model of the fifth degree can be represented by the following system of equations, where y represents the hook load and X is the Bit Depth:

yᵢ=w₀+w₁xᵢ+w₂xᵢ²+w₃xᵢ³+w₄xᵢ⁴+w₅xᵢ⁵

Y=X^{T}W

Although the above-represented system of equations is shown in the fifth degree, it is understood that a model of n dimensions can also be used by the prediction application to predict a stuck pipe. In some embodiments, the prediction application can apply an adaptive linear regression algorithm (ALRA) having no previous training, for example at start-up. In such a situation, the prediction application can take a series of samples of bit depth and hook load for a given well. The hook load samples can be taken while moving the drill string out of the hole, or at other times. Additionally, the prediction application can be configured to ignore readings that are higher than a predefined hook load threshold. The hook load threshold can be defined in order to maximize a true positive rate and minimize a false-positive rate. Such a hook load threshold can be preferably approximately 270 klbs, or another value. The threshold can be determined by the drilling engineer or by learning it from other wells.

After collecting a predefined number of hook load readings, the prediction application generates the initial linear regression model. The predefined number of hook load readings can preferably be five readings, or another number of readings. For subsequent readings of hook load values at a provided bit depth, the prediction application calculates a normal hook load value at the provided bit depth using the linear regression model.

The prediction application then compares the normal hook load value to the detected hook load value. If the detected hook load value is greater than the normal hook load value, the prediction application generates an alert that the pipe may become stuck. Otherwise, the detected hook load value and the provided bit depth are added to the linear regression model for subsequent use.

In other embodiments, the prediction application can generate a linear regression model for a given well based on training data from other wells. In such an embodiment, the prediction application selects a predefined number of training wells. The predefined number of training wells can be preferably eight wells, or another number. The prediction application then tries to find the value of W that minimizes the sum square error using hook load readings for the training wells at corresponding bit depths. As above, the hook load readings for the training wells can be taken while moving the drill string out of the training well hole(s), or at another time. Additionally, the prediction application can be configured to ignore or reject readings having a hook load value above a predefined hook load threshold. Such a predefined hook load threshold can be preferably 170 kbps, or another value. The threshold can be determined by the drilling engineer or by learning it from other wells.

After generating the linear regression model from the training wells, the prediction application calculates a normal hook load value at the provided bit depth using the linear regression model. The prediction application then compares the normal hook load value to the detected hook load value. If the detected hook load value is greater than the normal hook load value, the prediction application generates an alert that the pipe may become stuck, or take another action. In one or more aspects the model can record the delta or difference between the detected hook load value and the normal hook load value and use this difference as the basis for an alert.

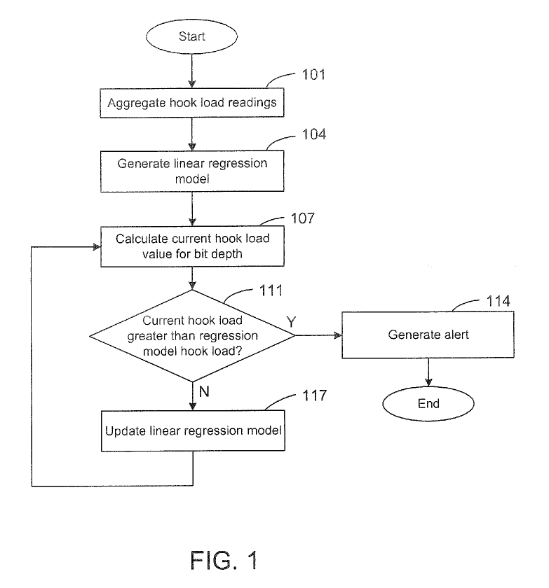

Referring next to FIG. 1, shown is a flowchart that provides one example of the operation of a portion of the prediction application according to various embodiments. It is understood that the flowchart of FIG. 1 provides merely an example of the many different types of functional arrangements that can be employed to implement the operation of the portion of the prediction application as described herein. As an alternative, the flowchart of FIG. 1 can be viewed as depicting an example of elements of a method implemented in a computing environment according to one or more embodiments.

Beginning with box 101, the prediction application aggregates a series of readings of bit depth at a corresponding hook load for a given well. In some embodiments, the prediction application can be configured to ignore readings that are higher than a predefined hook load threshold. Such a hook load threshold can be preferably approximately 270 klbs, or another value. The threshold can be determined by the drilling engineer or by learning it from other wells.

Next, after aggregating a predefined number of hook load readings, the prediction application generates the initial linear regression model in box 104. The predefined number of hook load readings can be five readings, or another number of readings. Once the prediction application has generated the initial linear regression model, the prediction application obtains a current hook load at a current bit depth in box 107. In box 111, the prediction application compares the current hook load value with a normal hook load value generated from the linear regression model at the current bit depth. If the current hook load value is greater than the normal hook load value, the operation proceeds to box 114 where the prediction application generates an alert that the pipe may become stuck, after which the process ends. Otherwise, if the current hook load is less than or equal to the normal hook load, the process advances to box 117 where the prediction application updates the linear regression model with the current hook load and current bit depth. Alternatively the alert can be based on an amount of difference, or the delta, between the current hook load and a normal hook load. For example an alert can be set not simply based on a difference between the two values, but instead if the difference exceeds a selected delta or amount of difference between the two values. The process then returns to box 107 where subsequent hook load values can be calculated.

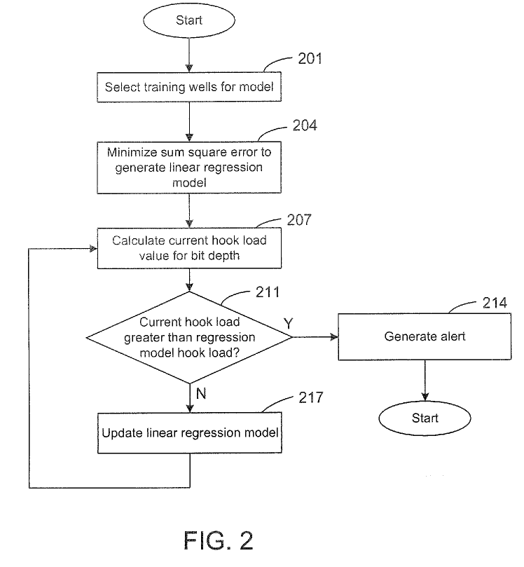

Turning now to FIG. 2, shown is a flowchart that provides one example of the operation of a portion of the prediction application according to various embodiments. It is understood that the flowchart of FIG. 2 provides merely an example of the many different types of functional arrangements that can be employed to implement the operation of the portion of the prediction application as described herein. As an alternative, the flowchart of FIG. 2 can be viewed as depicting an example of elements of a method implemented in a computing environment according to one or more embodiments.

Beginning with box 201, the prediction application selects a predefined number of training wells from which the linear regression model will be generated. The predefined number of training wells can be eight training wells, or another number of training wells. Next, in box 104, the prediction application generates the linear regression model using hook load readings at corresponding bit depths from the training well(s). The linear regression model can be generated to find the value of W that minimizes the sum square error.

Once the prediction application has generated the initial linear regression model, the prediction application obtains a current hook load at a current bit depth in box 207. In box 211, the prediction application compares the current hook load value with a normal hook load value generated from the linear regression model at the current bit depth. If the current hook load value is greater than the normal hook load value, the operation proceeds to box 214 where the prediction application generates an alert that the pipe may become stuck, after which the process ends. Otherwise, if the current hook load is less than or equal to the normal hook load, the process advances to box 217 where the prediction application updates the linear regression model with the current hook load and current bit depth. The process then returns to box 207 where subsequent hook load values are calculated. Alternatively the alert can be based on an amount of difference, or the delta, between the current hook load and a normal hook load. For example an alert can be set not simply based on a difference between the two values, but instead if the difference exceeds a selected delta or amount of difference between the two values.

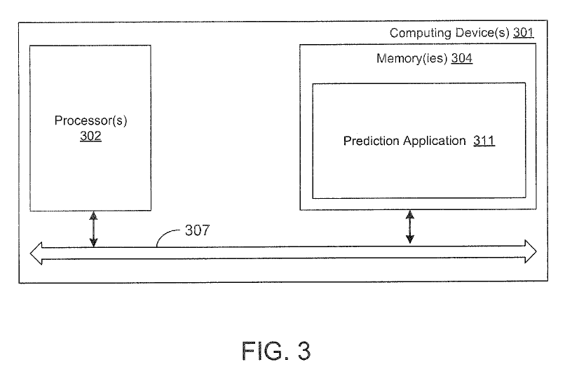

With reference to FIG. 3, shown is a schematic block diagram a computing device 301 according to an embodiment of the present disclosure. The computing device 301 includes at least one processor circuit, for example, having a processor 302 and a memory 304, both of which are coupled to a local interface 307. To this end, the computing device 301 can comprise, for example, at least one server computer or like device. The local interface 307 can comprise, for example, a data bus with an accompanying address/control bus or other bus structure as can be appreciated.

Stored in the memory 304 are both data and several components that are executable by the processor 302. In particular, stored in the memory 304 and executable by the processor 302 are a prediction application 311, and potentially other applications. In addition, an operating system can be stored in the memory 304 and executable by the processor 302.

It is understood that there may be other applications that are stored in the memory 304 and are executable by the processor 302 as can be appreciated. Where any component discussed herein is implemented in the form of software, any one of a number of programming languages can be employed such as, for example, C, C++, C#, Objective C, Java® , JavaScript®, Perl, PHP, Visual Basic® , Python Ruby, Flash®, or other programming languages.

A number of software components are stored in the memory 304 and are executable by the processor 302. In this respect, the term “executable” means a program file that is in a form that can ultimately be run by the processor 302. Examples of executable programs can be, for example, a compiled program that can be translated into machine code in a format that can be loaded into a random access portion of the memory 304 and run by the processor 302, source code that can be expressed in proper format such as object code that is capable of being loaded into a random access portion of the memory 304 and executed by the processor 302, or source code that can be interpreted by another executable program to generate instructions in a random access portion of the memory 304 to be executed by the processor 302, etc. An executable program can be stored in any portion or component of the memory 304 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 304 is defined herein as including both volatile and nonvolatile memory and data storage components. Volatile components are those that do not retain data values upon loss of power. Nonvolatile components are those that retain data upon a loss of power. Thus, the memory 304 can comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM can comprise, for example, static random access memory (SRAM), dynamic random access memory (DRAM), or magnetic random access memory (MRAM) and other such devices. The ROM can comprise, for example, a programmable read-only memory (PROM), an erasable programmable read-only memory (EPROM), an electrically erasable programmable read-only memory (EEPROM), or other like memory device.

Also, the processor 302 can represent multiple processors 302 and/or multiple processor cores and the memory 304 can represent multiple memories 304 that operate in parallel processing circuits, respectively. In such a case, the local interface 307 can be an appropriate network that facilitates communication between any two of the multiple processors 302, between any processor 302 and any of the memories 304, or between any two of the memories 304, etc. The local interface 307 can comprise additional systems designed to coordinate this communication, including, for example, performing load balancing. The processor 302 can be of electrical or of some other available construction.

Although the prediction application 311, and other various systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 1 and 2 show the functionality and operation of an implementation of portions of the prediction application 311. If embodied in software, each block can represent a module, segment, or portion of code that comprises program instructions to implement the specified logical function(s). The program instructions can be embodied in the form of source code that comprises human-readable statements written in a programming language or machine code that comprises numerical instructions recognizable by a suitable execution system such as a processor 302 in a computer system or other system. The machine code can be converted from the source code, etc. If embodied in hardware, each block can represent a circuit or a number of interconnected circuits to implement the specified logical function(s).

Although the flowcharts of FIGS. 1 and 2 show a specific order of execution, it is understood that the order of execution can differ from that which is depicted. For example, the order of execution of two or more blocks can be scrambled relative to the order shown. Also, two or more blocks shown in succession in FIGS. 1 and 2 can be executed concurrently or with partial concurrence. Further, in some embodiments, one or more of the blocks shown in FIGS. 1 and 2 can be skipped or omitted. In addition, any number of counters, state variables, warning semaphores, or messages can be added to the logical flow described herein, for purposes of enhanced utility, accounting, performance measurement, or providing troubleshooting aids, etc. It is understood that all such variations are within the scope of the present disclosure.

Also, any logic or application described herein, including the prediction application 311, that comprises software or code can be embodied in any non-transitory computer-readable medium for use by or in connection with an instruction execution system such as, for example, a processor 302 in a computer system or other system. In this sense, the logic can comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including, for example, static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein, including the prediction application, can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device 301, or in multiple computing devices in the same computing environment 103. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

### Experimental Data and Results

We now demonstrate a stuck pipe prediction using an embodiment of our system and method including the two learning algorithms: ALRA, and LRA. Due to the limitation of the given data and unbalanced classes, we evaluate the models using True Positive Rate (TPR), and False Positive Rate (FPR) instead of the accuracy. We define True Positive Rate (TPR) and False Positive rate (FPR), used to measure the accuracy of the algorithm, as follows:

$$TPR = \frac{TP}{TP + FN}$$

$$FPR = \frac{FP}{FP + TN}$$

TP (True Positive): is the sum of all TP in the testing data. Any Positive Data Point (PDP) that has an identified alert(s) within 1200 records reading ahead of the exact time of the labeled PDP is considered as 1 TP. (the average data reading frequency is 1 record every 3 second: 1200 record reading ahead of PDP is equal to 1 hour)
FN (False Negative): is the sum of all FN in the testing data. Any Positive Data Point (PDP) that has NO identified alert within 1200 records reading ahead of the exact time of the labeled PDP is considered as 1 FN.
FP (False Positive): is the sum of all FP in the testing data. For each 1200 records reading that have NO PDP and have any alert is considered as 1 FP.
TN (True Negative): is the sum of all TN in the testing data. For each 1200 records reading that have NO PDP and have NO alert is considered as 1 TN.
The accuracy calculation is done for the points starting from the first record reading till the first Positive Data Point. All data after that are not included in the calculation.

It will be understood by one skilled in the art, however, that other definitions for TPR and FPR and the values TP, FN, FP and TN can be used. For example, more record readings or fewer record readings can be applied, the frequency and duration of the readings can be higher or lower, and the accuracy calculation can be adjusted.

For the Adaptive Linear Regression Algorithm (ALRA), all wells are considered as testing data. Hence, no training data are required for the algorithm. However, the other algorithm (the LRA algorithm) uses random 8 wells for training and the remaining 4 wells for testing. For consistency the first algorithm randomly selects 4 wells in each run. The experiments were run multiple times for both algorithms, and average TPR/FPR are calculated. The data distributions are provided in Table 1.

TABLE 1

| Well name | Class | # Records |
|---|---|---|
| well-10 | 0 | 40609 |
| well-10 | 1 | 10 |
| well-11 | 0 | 39694 |
| well-11 | 1 | 303 |
| well-17 | 0 | 19899 |
| well-17 | 1 | 100 |
| well-18 | 0 | 33040 |
| well-18 | 1 | 245 |
| well-2 | 0 | 79599 |
| well-2 | 1 | 330 |
| well-25 | 0 | 52017 |
| well-25 | 1 | 47 |
| well-31 | 0 | 19793 |
| well-31 | 1 | 15 |
| well-32 | 0 | 54068 |
| well-32 | 1 | 48 |
| well-41 | 0 | 19955 |
| well-41 | 1 | 45 |
| well-5 | 0 | 17989 |
| well-5 | 1 | 100 |
| well-8 | 0 | 70140 |
| well-8 | 1 | 90 |
| well-9 | 0 | 39695 |
| well-9 | 1 | 302 |

### ALRA Experiment Results:

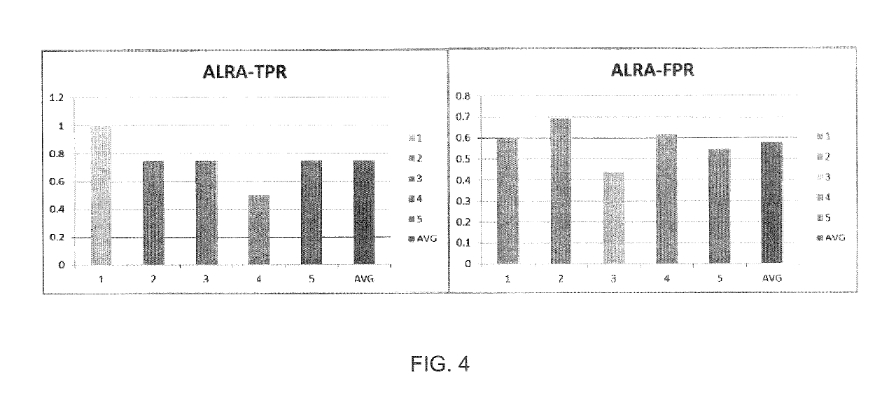

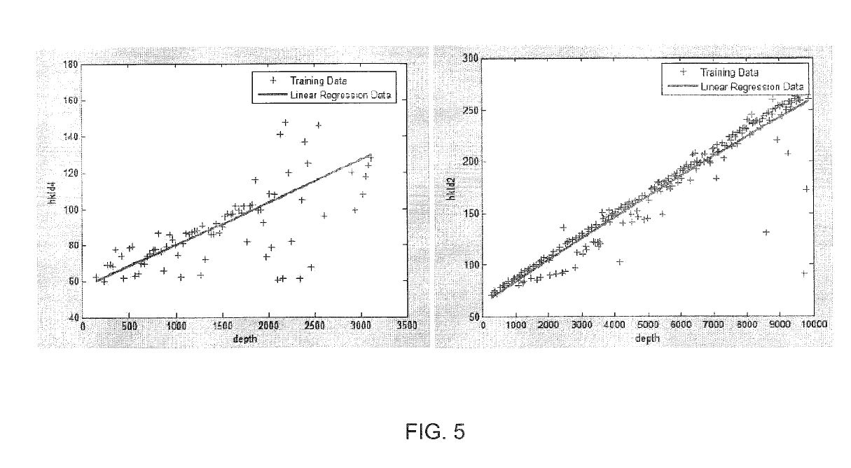

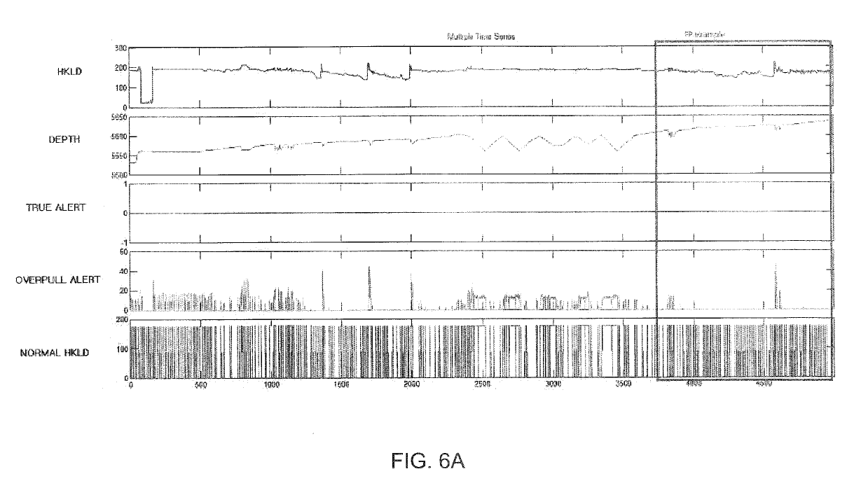

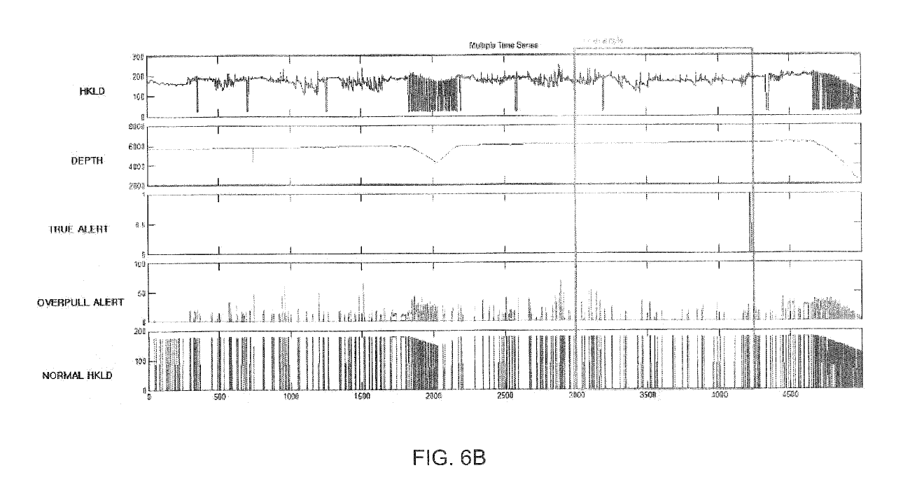

For ALRA experiment, 4 wells were selected randomly from the available 12 wells for testing in each run. The algorithm was run 5 times. As we can see from the ALRA-TPR, and ALRA-FPR charts (FIG. 4) the algorithm was able to predict on average 75% of the true alerts. Details of the experimental runs are provided in Table 2. FIG. 5 depicts charts showing the obtained regression model of different wells. FIGS. 6A and 6B depict charts showing some record readings and the alerts of Well-10.

### LRA Experiment Results:

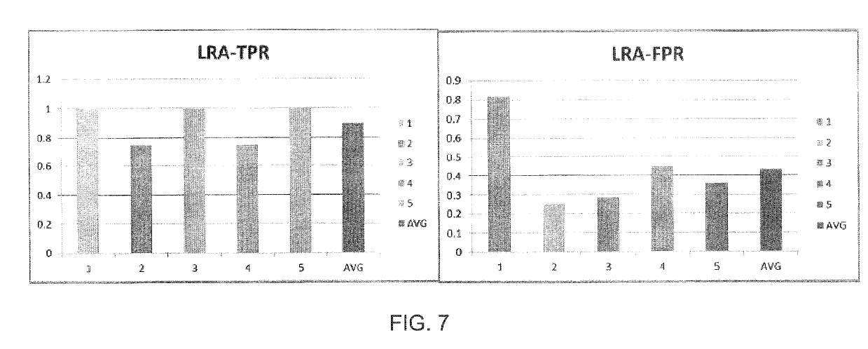

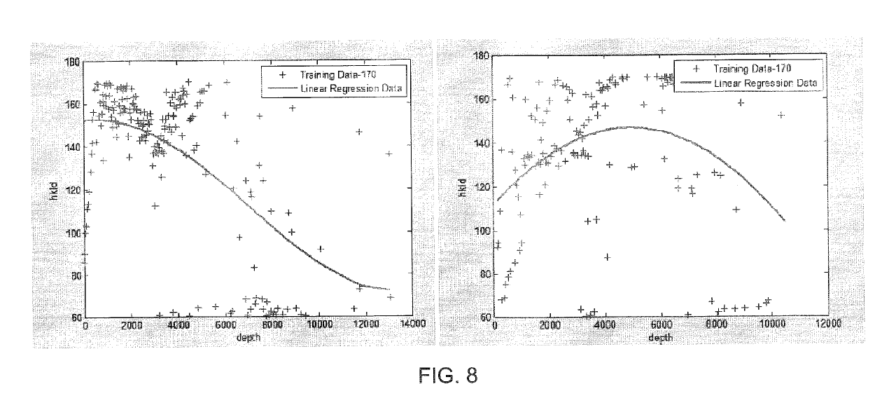

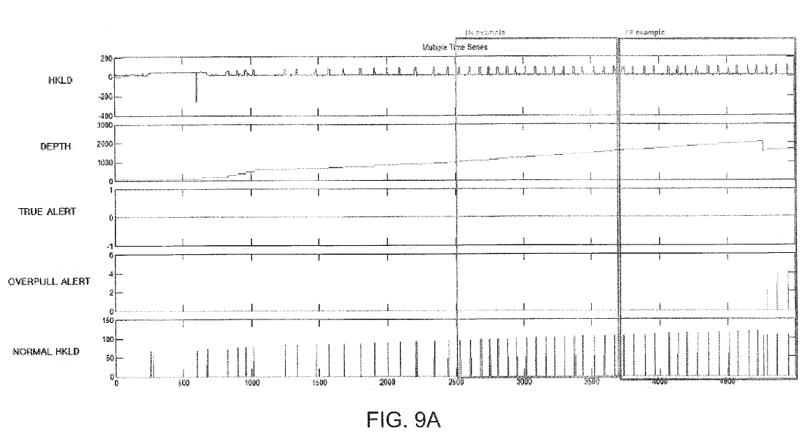

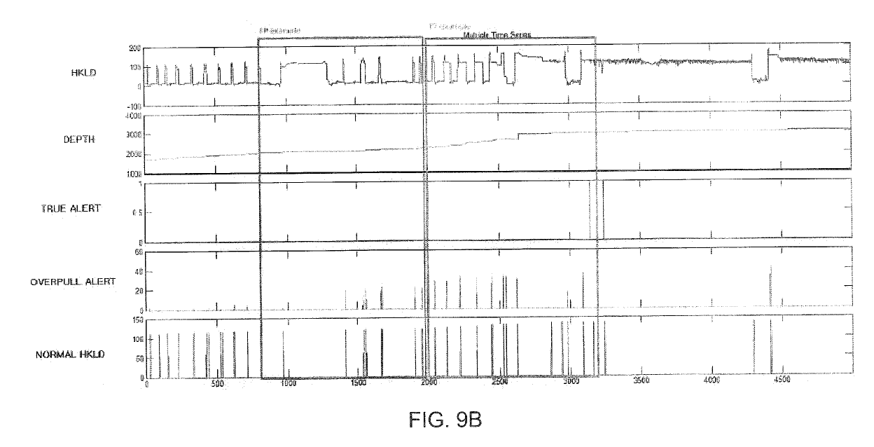

For LRA experiment, 8 wells were randomly selected from the available 12 wells for training to obtain a Linear Regression Model. Once training finishes, the remaining 4 wells are used for testing. The algorithm was run 5 times. As we can see from the ALRA-TPR, and ALRA-FPR charts (FIG. 7) the algorithm was able to predict on average 90% of the true alerts. Details of the experimental runs are provided in Table 3. FIG. 8 depicts charts showing the obtained regression model of different runs. FIGS. 9A and 9B depict charts showing some record readings and the alerts of Well-2.

### Implementation

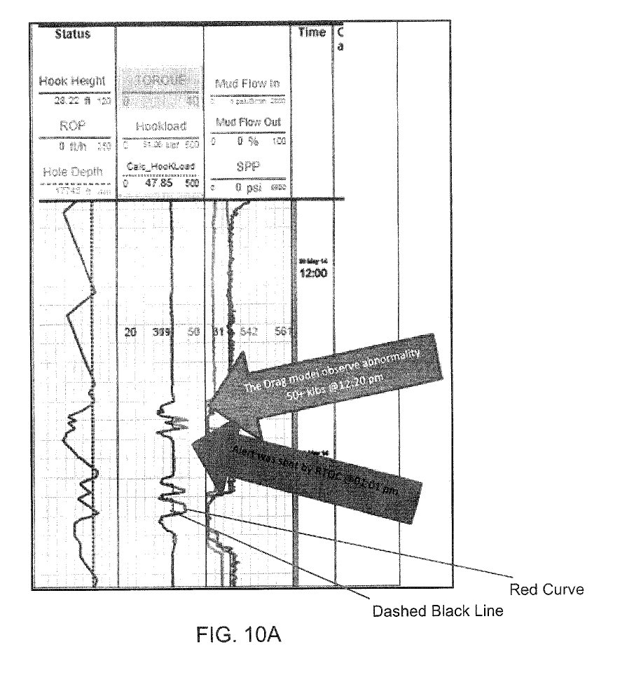

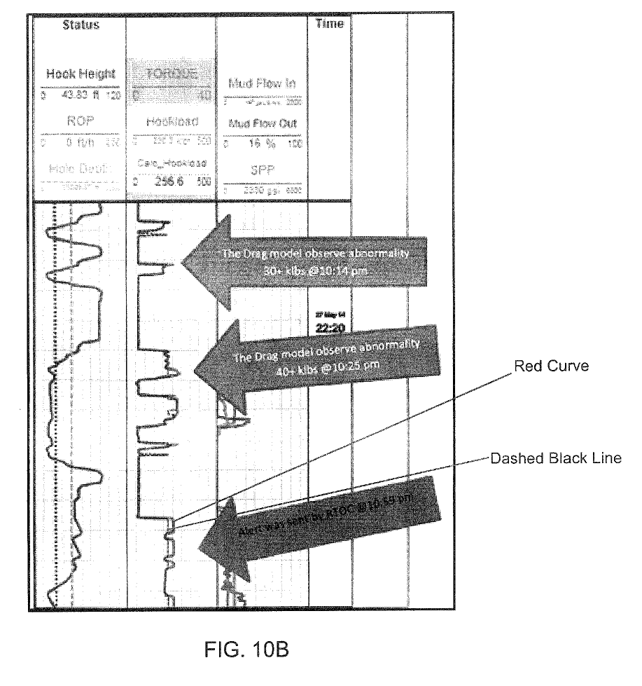

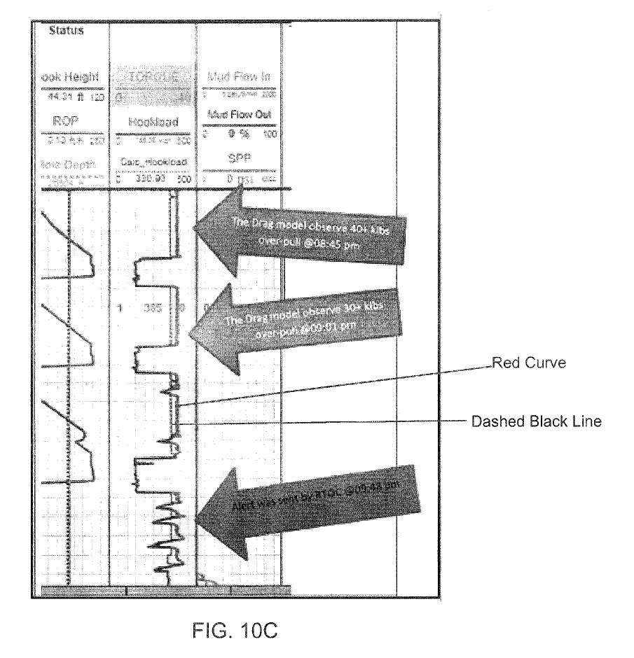

Our system and method was implemented and used for evaluation at Saudi Aramco Real-Time Drilling Operation Center, RTOC, one of the most advanced drilling operation monitoring centers worldwide. The center monitors critical operations and provides technical alerts and recommendations to engineers in the field to ensure operation safety and smoothness. During a pilot test of the proposed model, 25 wells were monitored by our system and method. It was able to observe and alert for every trouble related to over-pull and tight holes earlier than any alert issued by the RTOC engineers. FIGS. 10A-10C are charts showing some samples of the real alerts provided by our system and method. In FIGS. 10A-10C the “red” curve is the actual hook-load, the dashed black line is the calculated Hook-load by our system and method.

### Conclusion

Both algorithms have shown high True Positive Rate (75%-90%), which is an indication that such algorithms can be used as a real-time drilling trouble predictor. The Trained algorithm has shown even better TPR performance than the non-trained one. We can see that the False Positive Rate is high (40%-50%). In implementation, using our system and method we were able to provide alerts earlier than currently used methods. Other indicators, for example pump pressure-flow rate, and torque-RPM, can optionally be included in the model to expand its predictive capability.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure.

1. A method for stuck pipe prediction, comprising:
generating, by at least one computing device, a linear regression model based at least in part on a plurality of hook load readings each corresponding to a respective one of a plurality of bit depths;
obtaining, by the at least one computing device, a first hook load reading at another bit depth;
determining, by the at least one computing device, whether the first hook load reading is greater than a second hook load reading obtained from the linear regression model; and
generating, by the at least one computing device, an indication of a risk of stuck pipe in response to the first hook load reading being greater than the second hook load reading.

2. The method of claim 1, wherein generating the linear regression model further comprises obtaining the plurality of hook load readings from a well from which the first hook load reading is obtained.

3. The method of claim 2, wherein obtaining the plurality of hook load readings further comprises filtering those of the hook load readings meeting a predefined threshold.

4. The method of claim 1, wherein the linear regression model is generated in response to obtaining a number of hook load readings meeting a predefined threshold.

5. The method of claim 1, wherein generating the linear regression model further comprises obtaining the plurality of hook load readings from a plurality of wells distinct from a well from which the first hook load reading is obtained.

6. The method of claim 3, wherein the predefined threshold is preferably 170 klbs.

7. The method of claim 1, wherein the linear regression model is generated to minimize a sum squared error.

8. The method of claim 1, further comprising regenerating, by the computing device, the linear regression model based at least in part on the first hook load reading.

9. A system for stuck pipe prediction, comprising:
at least one device for receiving a plurality of hook load readings each corresponding to a respective one of a plurality of bit depths;
at least one computer processing device; and
an application executable in the at least one computer processing device, the application comprising logic that:
generates, by the at least one computer processing device, a linear regression model based at least in part on a plurality of hook load readings each corresponding to a respective one of a plurality of bit depths;
obtains, by the at least one computer processing device, a first hook load reading at another bit depth;
determines, by the at least one computing processing device, whether the first hook load reading is greater than a second hook load reading obtained from the linear regression model; and
generates, by the at least one computer processing device, an indication of a risk of stuck pipe in response to the first hook load reading being greater than the second hook load reading.

10. The system of claim 9, wherein generating the linear regression model further comprises obtaining the plurality of hook load readings from a well from which the first hook load reading is obtained.

11. The system of claim 10, wherein obtaining the plurality of hook load readings further comprises filtering those of the hook load readings meeting a predefined threshold.

12. The system of claim 9, wherein the linear regression model is generated in response to obtaining a number of hook load readings meeting a predefined threshold.

13. The system of claim 10, wherein generating the linear regression model further comprises obtaining the plurality of hook load readings from a plurality of wells distinct from a well from which the first hook load reading is obtained.

14. The system of claim 10, wherein the linear regression model is generated to minimize a sum squared error.

15. The system of claim 10, further comprising regenerating, by the computing device, the linear regression model based at least in part on the first hook load reading.

16. A non-statutory computer readable medium employing a program executable in at least one computing device, comprising code that:
generates, by at least one computing device, a linear regression model based at least in part on a plurality of hook load readings each corresponding to a respective one of a plurality of bit depths;
obtains, by the at least one computing device, a first hook load reading at another bit depth;
determines, by the at least one computer processing device, whether the first hook load reading is greater than a second hook load reading obtained from the linear regression model; and
generates, by the at least one computing device, an indication of a risk of stuck pipe in response to the first hook load reading being greater than the second hook load reading.

17. The non-statutory computer readable medium of claim 16, wherein generating the linear regression model further comprises obtaining the plurality of hook load readings from a well from which the first hook load reading is obtained.

18. The non-statutory computer readable medium of claim 17, wherein obtaining the plurality of hook load readings further comprises filtering those of the hook load readings meeting a predefined threshold.

19. The non-statutory computer readable medium of claim 16, wherein the linear regression model is generated in response to obtaining a number of hook load readings meeting a predefined threshold.

20. The non-statutory computer readable medium of claim 17, wherein generating the linear regression model further comprises obtaining the plurality of hook load readings from a plurality of wells distinct from a well from which the first hook load reading is obtained.
